(19) United States
(12) Patent Application Publication
(10) Pub. No.: US 2008/0248736 A1
(43) Pub. Date: Oct. 9, 2008

(54) Air conditioner for vehicle

(75) Inventors: Shinji Aoki, Chiryu-city (JP); Takuya Kataoka, Okazaki-city (JP)

Correspondence Address: HARNESS, DICKEY & PIERCE, P.L.C., P.O. BOX 828, BLOOMFIELD HILLS, MI, 48303, US

(73) Assignee: DENSO CORPORATION, Kariya-city (JP)

(21) Appl. No.: 12/080,222

(22) Filed: Mar. 31, 2008

(30) Foreign Application Priority Data
Apr. 3, 2007 (JP) 2007-097391
Nov. 1, 2007 (JP) 2007-284950

(51) Int. Cl. B60H 1/00

(52) U.S. Cl. 454/75; 62/244; 62/179

(57) ABSTRACT

An air conditioner for a vehicle includes an air conditioning unit for generating a conditioned air, an air-blowing outlet portion for blowing the conditioned air toward a target portion of a passenger in a passenger compartment of the vehicle, and a control unit adapted to conduct a cool-down control. The target portion includes a face area, a seat-contact portion and a hand area of the passenger, the seat-contact portion contacting a seat of the vehicle. The cool-down control includes a first blowing operation for blowing the conditioned air from the air-blowing outlet portion toward the face area, a second blowing operation for blowing the conditioned air from the air-blowing outlet portion toward the seat-contact portion and a third blowing operation for blowing the conditioned air from the air-blowing outlet portion toward the hand area. The first blowing operation, the second blowing operation and the third blowing operation successively begun.

### CROSS REFERENCE TO RELATED APPLICATION

This application is based on Japanese Patent Applications No. 2007-97391 filed on Apr. 3, 2007 and No. 2007-284950 filed on Nov. 1, 2007, the disclosures of which are incorporated herein by reference.

### FIELD OF THE INVENTION

The present invention relates to an air conditioner for a vehicle.

### BACKGROUND OF THE INVENTION

For example, Japanese Unexamined Patent Application Publication No. 2006-76503 describes a vehicular air conditioner that conducts a cool-down control. The described air conditioner determines that it is in an initial stage of the cool-down control when a difference between an inside air temperature and a setting temperature or a difference between the inside air temperature and a target air-blowing temperature TAO is equal to or higher than a predetermined temperature. In the initial stage of the cool-down operation, conditioned air is blown toward a face of a passenger in a spot-like direct manner for a predetermined period of time, and is successively supplied to a contact portion of a passenger with an interior material for cooling the contact portion, in addition to a blowing operation of the conditioned air toward the face.

### SUMMARY OF THE INVENTION

In a passenger body, there are other portions that easily sense coldness in an air conditioning operation, in addition to the face and the contact portion with the interior material, such as a seat. Also, in a vehicular air conditioner, it is generally required to save power consumption and improve efficiency. The present invention is made in view of the foregoing matter, and an object of the present invention is to provide an air conditioner for a vehicle, which is capable of improving air conditioning efficiency while saving power. Another object of the present invention is to provide an air conditioner for a vehicle, which is capable of improving an immediate effect of a cool-down control.

According to an aspect of the present invention, an air conditioner for a vehicle includes an air conditioning unit for generating a conditioned air, an air-blowing outlet portion that is in communication with the air conditioning unit and configured to blow the conditioned air toward a target portion of a passenger in a passenger compartment of the vehicle, and a control unit for conducting an air-blowing control. The target portion of the passenger includes a face area, a seat-contact portion and a hand area of the passenger, the seat-contact portion contacting a seat of the vehicle. The control unit is adapted to conduct a cool-down control including a first blowing operation for blowing the conditioned air toward the face area, a second blowing operation for blowing the conditioned air toward the seat-contact portion, and a third blowing operation for blowing the conditioned air toward the hand area. The first blowing operation, the second blowing operation and the third blowing operation are successively begun.

The first blowing operation, the second blowing operation and the third blowing operation are successively begun, considering distribution of cold points of a human skin and efficiency of heat exchange in a human body.

For example, the distribution of cold points, which sense the cold, is high in a face. Also, perspiration is high in the face. Further, the face is exposed to the air and has high coefficient of heat transfer. Thus, a passenger feel the cold the most in his face. Therefore, in the cool-down control, the first blowing operation for blowing the conditioned air toward the face area is begun first. The seat-contact portion has high perspiration and contacts the seat having a large heat mass. Therefore, the second blowing operation for blowing the conditioned air toward the seat-contact portion is begun after the first blowing operation is begun. As such, a surface temperature of the passenger body is immediately cooled. For example, the seat-contact portion includes the hip and the back, which correspond to a seat cushion and a backrest of the seat, respectively.

Furthermore, hands of the passenger are exposed to the air and have high coefficient of heat transfer, similar to the face. Thus, the passenger will want to cool the hands, following the face and the seat-contact portion. Therefore, the third blowing operation for blowing the conditioned air toward the hand area is begun after the second blowing operation is begun.

In general, a human body maintains a deep body temperature in a predetermined temperature range by radiating heat from extremities such as hands and foot through blood circulation. In other words, the deep body temperature, which is increased by the outside air and the like, is effectively lowered by cooling the extremities.

Further, the deep body temperature is less changed than the surface temperature. Therefore, the first to third blowing operations are successively begun so that the deep body temperature is lowered after the surface temperature of the body where the distribution of the cold points is high is lowered. Accordingly, air conditioning efficiency of the air conditioner improves. Further, the timing of the first to third blowing operations improves an immediate effect of the air conditioning. Thus, air conditioning efficiency of the air conditioner improves while saving the power.

For example, in a case where the air-blowing outlet portion includes a plurality of air-blowing ports, the control of the control unit includes a selecting operation for selecting an air-blowing port for blowing the conditioned air toward a predetermined area from a plurality of air-blowing ports, that is, determining from which air-blowing port the conditioned air is to be blown. Alternative to or in addition to the selecting operation, the control includes a direction controlling operation for controlling a flow direction of conditioned air from the air-blowing outlet portion. Further, the control may include a circulation operation for circulating the air between the air conditioning unit and the passenger compartment by suctioning inside air. The control unit controls operations of the air conditioning unit.

### BRIEF DESCRIPTION OF THE DRAWINGS

Other objects, features and advantages of the present invention will become more apparent from the following detailed description made with reference to the accompanying drawings, in which like parts are designated by like reference numbers and in which:

FIG. 1 is a general perspective view of a part of a passenger compartment of a vehicle having an air conditioner according to a first embodiment of the present invention;

FIG. 2 is a front view of an air-flow direction adjustment grill of the air conditioner according to the first embodiment;

FIG. 3 is a schematic cross-sectional view of an internal air conditioning unit of the air conditioner according to the first embodiment;

FIG. 4 is a schematic diagram of the air conditioner according to the first embodiment;

FIG. 5 is a flowchart showing a cool-down control of the air conditioner according to the first embodiment;

FIG. 6 is a graph for showing the distribution of cold points of a human skin;

FIG. 7A is a graph for showing a rate of change of blood flow of a human body;

FIG. 7B is a graph for showing perspiration per unit area of a human body;

FIG. 7C is a graph for showing a coefficient of heat transfer of a human body;

FIG. 8A to 8D are schematic views for showing blowing operations of the cool-down control according to the first embodiment;

FIG. 9 is a perspective view for explaining operations of the air-flow direction adjustment device according to the first embodiment;

FIG. 10 is a perspective view for showing a blowing operation and a suctioning operation of the cool-down control according to the first embodiment;

FIG. 11 is a schematic cross-sectional view of an interior air conditioning unit according to a second embodiment of the present invention; and

FIG. 12 is a schematic view of a part of a passenger compartment of a vehicle having an air conditioner according to another embodiment of the present invention.

### DETAILED DESCRIPTION OF EXEMPLARY EMBODIMENT

### First Embodiment

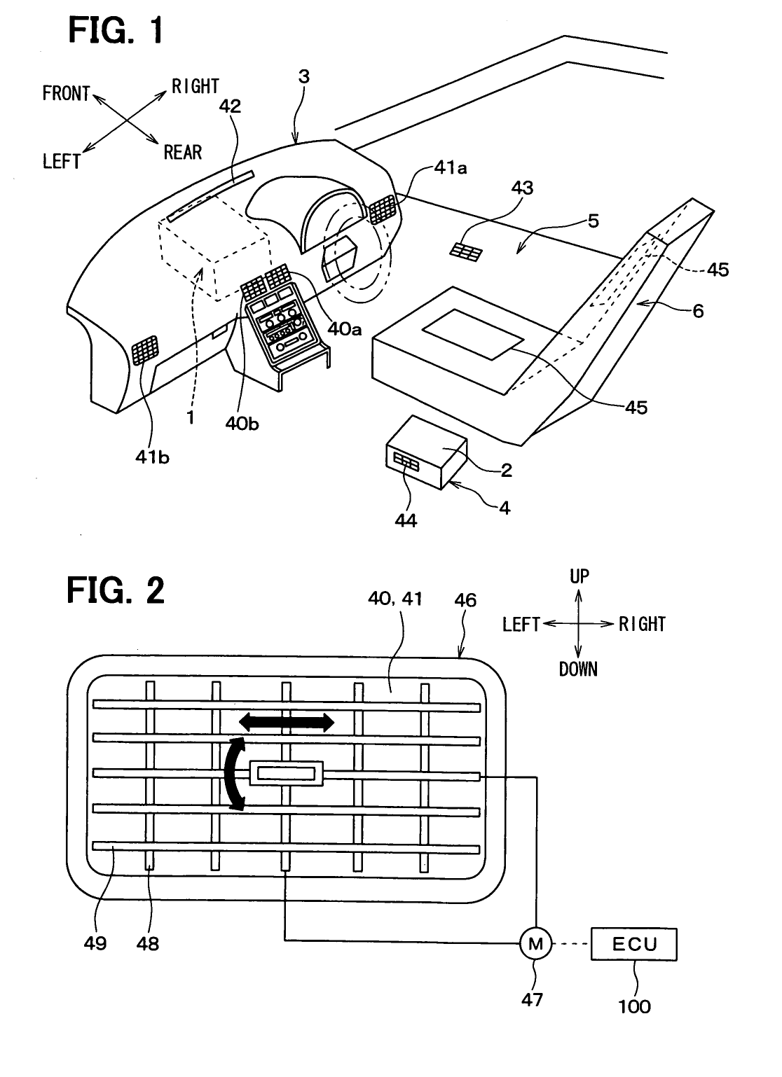

A first embodiment of the present invention will be described with reference to FIGS. 1 to 10. Referring to FIG. 1, an air conditioner of the first embodiment generally includes an interior air conditioning unit 1 as a main air conditioning unit and a console air conditioning unit 2 as an auxiliary air conditioning unit. An instrument panel 3 is disposed at a front part of a passenger compartment, that is, in front of front seats and entirely over the width of the passenger compartment in a vehicle right and left direction. The interior air conditioning unit 1 is mounted in a space defined in the instrument panel 3. Thus, the interior air conditioning unit 1 is also referred to as a front air conditioning unit. The console air conditioning unit 2 is mounted in a console 4 that is disposed between front seats 6, such as between a front right seat (e.g., driver's seat) and a front left seat (e.g., front passenger's seat).

The instrument panel 3 has face air-blowing outlet portions (face air-blowing ports) 40, 41 defining openings for blowing air that has been conditioned in temperature by the interior air conditioning unit 1 (hereinafter, conditioned air) into the passenger compartment, such as toward the front seats 6. Further, the instrument panel 3 has a defroster air-blowing outlet portion 42 defining openings for blowing the conditioned air at its front-most position. The defroster air-blowing outlet portion 42 has a predetermined length in the right and left direction. Also, foot air-blowing outlet portions are formed under the instrument panel 3 and define openings for supplying the conditioned air toward the foot areas of the front seats 6.

The face air-blowing outlet portions 40, 41 face the front seats 6. The face air-blowing outlet portion 40 includes a center-right face air-blowing outlet portion 40a and a center-left air-blowing outlet portion 40b. The center-right face air-blowing outlet portion 40a and the center-left air-blowing outlet portion 40b are located adjacent to the center of the instrument panel 3 with respect to the right and left direction of the vehicle. The face air-blowing outlet portion 41 includes a right side face air-blowing outlet portion 41a located adjacent to a right end of the instrument panel 3 and a left side face air-blowing outlet portion 41b disposed adjacent to a left end of the instrument panel 3.

Each of the face air-blowing outlet portions 40, 41 (40a, 40b, 41a, 41b) is provided with an air-flow direction adjustment grill 46 as air-flow direction adjustment device, as shown in FIG. 2. The air-flow direction adjustment grill 46 includes a vertical louver 48 and a lateral louver 49. The vertical louver 48 is swung in the right and left direction by a servomotor 47. A flow direction of air blown from each face air-blowing outlet portion 40, 41 is controlled with respect to the right and left direction of the vehicle by the vertical louver 48. The lateral louver 49 is swung in an up and down direction by the servomotor 47. A flow direction of air blown from each face air-blowing outlet portion 40, 41 is also controlled with respect to the up and down direction by the lateral louver 49.

As shown in FIG. 1, door air-blowing outlet portions (door air-blowing ports) 43 are formed on side doors (right and left doors) 5 of the vehicle. The door air-blowing outlet portions 43 define openings for blowing the conditioned air generated in the interior air conditioning unit 1 into the passenger compartment.

The face air-blowing outlet portions 40, 41, the defroster air-blowing outlet portions 42, the foot air-blowing outlet portions, and the door air-blowing outlet portions 43 are in communication with the interior air conditioning unit 1 through ducts (not shown), respectively.

The console 4 has console air-blowing outlet portions (console air-blowing ports) 44 defining openings for blowing conditioned air generated in the console air conditioning unit 2 toward the front seats 6. The console air-blowing outlet portions 44 include a right console air-blowing outlet portion (not shown) for blowing the conditioned air toward the front right seat and a left console air-blowing outlet portion for blowing the conditioned air toward the front left seat.

Each seat 6 has a seat air-blowing outlet portion 45 defining small apertures for blowing the conditioned air generated in the console air conditioning unit 2 from a surface of a seat cushion and a surface of a seat back. Namely, the seat air-blowing outlet portion 45 is formed in a contact area of the seat 6, the contact area makes contact with a passenger seated on the seat 6.

The console air-blowing outlet portions 44 and the seat air-blowing outlet portions 45 are in communication with the console air conditioning unit 2 through ducts (not shown), respectively. The door air-blowing outlet portions 43 and the console air-blowing outlet portions 44 serve as side air-blowing outlet portions.

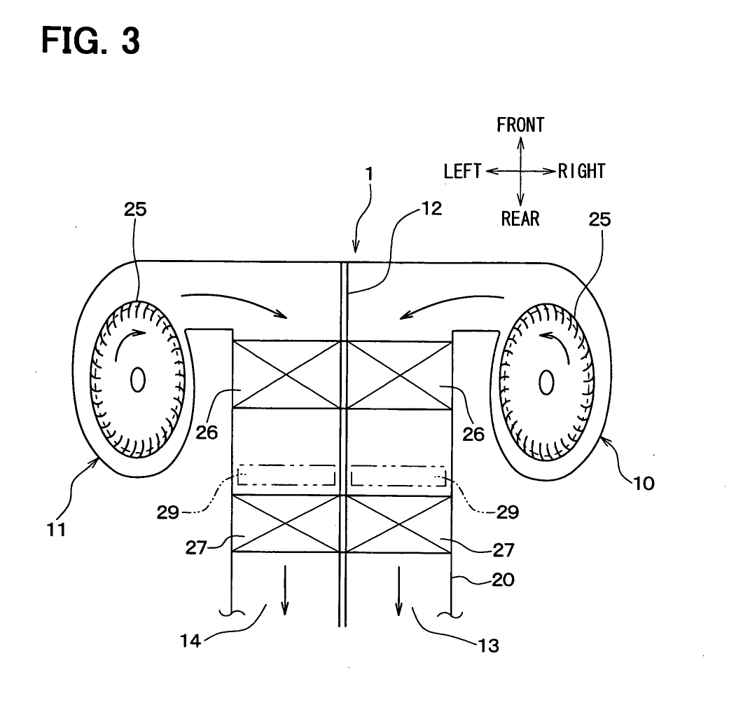

As shown in FIG. 3, the interior air conditioning unit 1 is a right and left temperature independent control-type unit that is capable of independently controlling the temperature of air to be introduced to a right space and a left space of the passenger compartment.

The interior air conditioning unit 1 has an air conditioning case 20. The case 20 forms a right air passage (e.g., driver's seat-side passage) 13 and a left air passage (e.g., assistant driver's seat-side passage) 14. The right air passage 13 and the left air passage 14 are separated from each other by a partition wall 12. Thus, the interior air conditioning unit 1 generally has a right air conditioning unit 10 (hereinafter, right unit 10) and a left air conditioning unit 11 (hereinafter, left unit 11). The right unit 10 adjusts the temperature of air to be introduced to the right space of the passenger compartment, and the left unit 11 conditions air to be introduced to the left space of the passenger compartment.

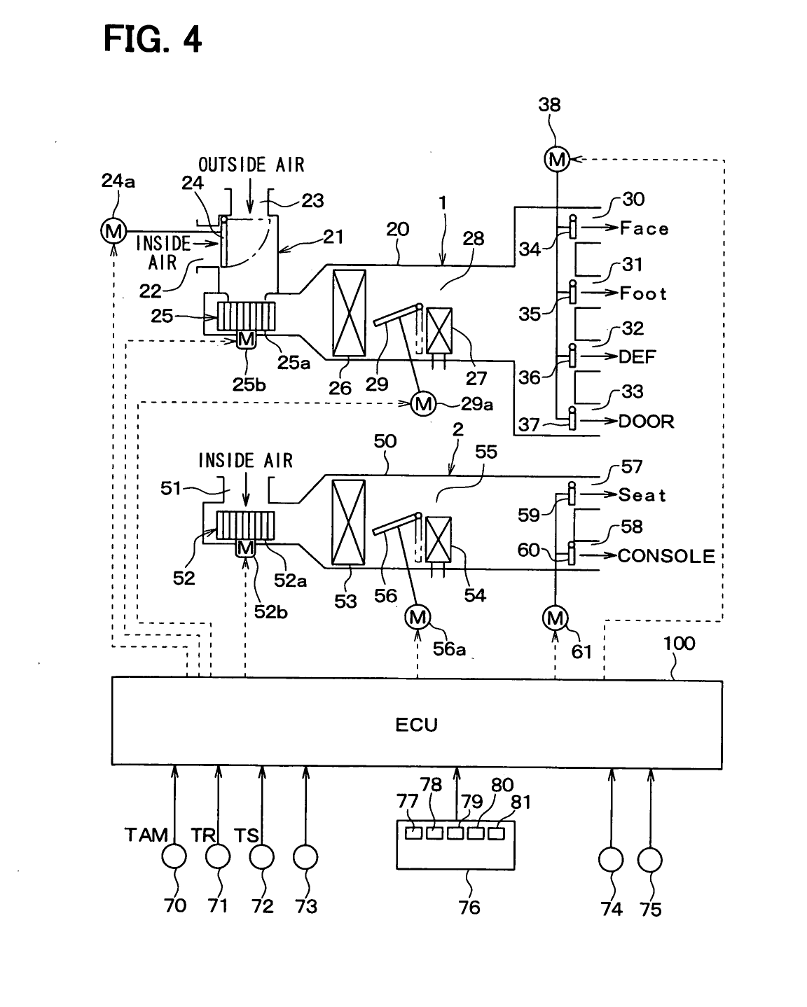

Each of the right unit 10 and the left unit 11 includes an inside/outside air switching device 21, a blower 25, an evaporator 26, a heater core 27, an air mix door 29 and openings, such as a face opening 30, a foot opening 31, a defroster opening 32 and a door opening 33. Because the right unit 10 and the left unit 11 have the similar structure, a structure of the right unit 10 will be exemplarily described hereinafter and shown in FIG. 4.

As shown in FIG. 4, the inside/outside air switching device 21 is disposed at an upstream-most position in the air conditioning case 20 with respect to a flow of air. The inside/outside air switching device 21 has an inside air introduction port 22 for introducing air inside of the passenger compartment (hereinafter, inside air) into the case 20, and an outside air introduction port 23 for introducing air outside of the passenger compartment (hereinafter, outside air) into the case 20. Further, the inside/outside air switching device 21 includes an inside/outside air switching door 24 as a switching member for switching the inside air introduction port 22 and the outside air switching port 23. The inside/outside air switching door 24 is driven by a servomotor 24a, for example.

In the present embodiment, the inside air introduction port 22 is in communication with an air suctioning portion 90 that is located at a foot area of a passenger seated on the front right seat, such as a lower area of the front right seat through an inside air introduction duct. With regard to the left unit 11, the inside air introduction port 22 is in communication with an air suctioning portion (not shown) that is located at a foot area of a passenger seated on the front left seat, such as a lower area of the front left seat. The air suctioning portions define suction openings for suctioning the conditioned air that has been blown from the air-blowing outlet portions into the passenger compartment, thereby circulating the air in the passenger compartment and the interior air conditioning unit 1.

The blower 25 is disposed downstream of the inside/outside air switching device 21 in the case 20 for drawing the air from the inside/outside air switching device 21 and blowing the air toward the passenger compartment. The blower 25 includes a centrifugal multi-blade fan 25a and an electric motor 25b for driving the fan 25a.

The evaporator 26 is disposed downstream of the blower 25, as a cooling heat exchanger for cooling the air blown by the blower 25. The evaporator 26 is one of elements of a refrigerant cycle (not shown) and performs heat exchange between the air blown by the blower 25 and a low pressure refrigerant flowing inside of the evaporator 26, thereby generating cooled air. In other words, the low pressure refrigerant is evaporated by receiving heat from the air, and thus the air is cooled.

The heater core 27 is disposed downstream of the evaporator 26, as a heating heat exchanger for heating the cooled air generated by the evaporator 26. The heater core 27 performs heat exchange between the cooled air and a heat medium such as an engine coolant flowing inside of the heater core 27, thereby reheat the air. Further, a bypass passage 28 is formed beside the heater core 27 in the case 20 for allowing the cooled air generated by the evaporator 26 to bypass the heater core 27.

The air mix door 29 is disposed between the evaporator 26 and the heater core 27. The air mix door 29 is rotatably supported in the case 20. For example, the air mix door 29 is rotated by a servomotor 29a, so that a rotational position, that is, an opening degree of the air mix door 29 is controlled.

Thus, a ratio of the volume of air passing through the heater core 27 to the volume of air passing through the bypass passage 28 is controlled in accordance with the opening degree of the air mix door 29. As such, the temperature of air blown into the passenger compartment, such as the right area of the passenger compartment, is controlled.

The case 20 has the face opening 30, the foot opening 31, the defroster opening 32, and the door opening 33 at the downstream position of the right passage 13. Further, a face door 34, a foot door 35, a defroster door 36 and a side door 37 are rotatably supported at upstream positions of the face opening 30, the foot opening 31, the defroster opening 32 and the door opening 33, respectively. The face door 34, the foot door 35, the defroster door 36 and the side door 37 are operated by a servomotor 38 through a link mechanism (not shown) for opening and closing the respective openings 30, 31, 32, 33.

The face opening 30 is in communication with the center right face air-blowing outlet portion 40 and the right side face air-blowing outlet portion 41a through a face duct (not shown). With regard to the left unit 11, the face opening 30 is in communication with the center left face air-blowing outlet portion 40b and the left side ace air-blowing outlet portion 41b through a face duct (not shown).

The foot opening 31 is in communication with the right foot air-blowing outlet portion through a foot duct (not shown). The defroster opening 32 is in communication with the defroster opening 42 through a defroster duct (not shown). The door opening 33 is in communication with the right door air-blowing outlet portion 43 through a door duct (not shown).

The console air conditioning unit 2 basically has a similar structure as the interior air conditioning unit 1. However, the console air conditioning unit 2 does not have a structure for the right and left independent temperature control. Also, the console air conditioning unit 2 does not have the inside/outside air switching device. Further, arrangement of openings are different from the arrangement of the openings 30, 31, 32, 33 of the interior air conditioning unit 1. Hereinafter, a structure of the console air conditioning unit 2 will be briefly described.

The console air conditioning unit 2 has a console air conditioning case 50. The case 50 forms an air passage therein. The air passage is, for example, formed such that air flows toward the front seats and rear seats. The case 50 has an air suctioning portion 51 at an upstream-most position with respect to the air flow therein. The air suctioning portion 51 defines an opening for suctioning the air in the passenger compartment into the case 50.

A blower 52 is disposed downstream of the air suctioning portion 51 in the case 50 for blowing the air toward the passenger compartment. An evaporator 53 is disposed downstream of the blower 52 as a cooling heat exchanger for cooling the air blown by the blower 52.

A heater core 54 is disposed downstream of the evaporator 53 for heating air (cooled air) that has passed through the evaporator 53. The case 50 forms a bypass passage 55 beside the heater core 54 for allowing the cooled air that has passed through the evaporator 53 to bypass the heater core 54. An air mix door 56 is disposed between the evaporator 53 and the heater core 54.

The case 50 has a seat opening 57 and a console opening 58 at the downstream-most position with respect to the air flow. Further, a seat door 59 and a side door 60 are rotatably disposed upstream of the seat opening 57 and the console opening 58, respectively, for opening and closing the seat opening 57 and the console opening 58. The seat door 59 and the console door 58 are driven by a servomotor 61 through a link mechanism (not shown).

The seat opening 57 is in communication with the seat air-blowing outlet portions 45 through a seat duct (not shown) for blowing the conditioned air generated in the console air conditioning unit 2 from the seats 6. The console opening 58 is in communication with the console air-blowing outlet portions 44 through a console duct (not shown) for blowing the conditioned air generated in the console air conditioning unit 2 toward upper bodies of front passengers.

The vehicular air conditioner further includes an air conditioner control unit (ECU) 100, which is constructed of a microcomputer including a CPU, a ROM, a RAM and the like and peripheral circuits. The control unit 100 performs computations and processing based on an air conditioning control program stored in the ROM. Thus, the control unit 100 conducts an air blowing control.

The control unit 100 receives sensor signals from various sensors such as an outside air sensor 70, an inside air sensor 71, a solar radiation sensor 72, a seat temperature sensor 73, a seat sensor 74, an IR sensor 75 and the like. Also, the control unit 100 receives signals in accordance with manipulations of air conditioner operation switches of an air conditioner control panel 76, such as air-blowing mode switch 77, an air-conditioner switch 78, a blower switch 79, an auto-switch 80, a temperature setting switch 81 and the like.

The motors 25b, 52b of the blowers 25, 52, and the servomotors 24a, 29a, 56a, 38, 47, 61 as driving devices for driving the associated devices are electrically connected to an output side of the control unit 100. The motors 25b, 52b, and the servomotors 24a, 29a, 56a, 38, 47, 61 are controlled by the control unit 100.

The outside air sensor 70 detects an outside air temperature TAM. The inside air sensor 71 detects an inside air temperature TR. The solar radiation sensor 72 detects the amount of solar radiation TS radiated into the passenger compartment. The seat temperature sensor 73 detects a temperature of the surface of the seat 6.

The seat sensor 74 detects a seated condition of each seat 6. That is, the seat sensor 74 is provided to determine whether or not each seat 6 is occupied by a passenger, and serves as a passenger detecting device. For example, the seat sensor 74 is constructed of a normally opened-switch and is mounted in the seat cushion that supports the hip of a passenger. Thus, a contact of the switch is closed, that is, the switch is on when a load is applied to the seat cushion in a downward direction.

The IR sensor 75 detects a surface temperature of a passenger in a noncontact manner, as a temperature detecting device. The IR sensor 75 includes infrared light detecting elements arranged in the matrix shape for detecting temperature distribution of a predetermined detection region set in the passenger compartment. The IR sensor 75 is, for example, arranged at a position close to a rearview mirror that is disposed at an upper portion of a windshield. The predetermined detection region is set to a surface of a passenger, such as, the face, the chest, the waist and the like.

The air-blowing mode switch 77 is provided for manually selecting air-blowing modes that are set in accordance with positions of the air-blowing mode doors 34, 35, 36, 37, 59, 60. The air-conditioner switch 78 is configured to output a signal indicative of an operation command signal of the interior air conditioning unit 1. The blower switch 79 is provided for manually setting the volume of air blown by the blower 25. The auto-switch 80 is configured to output a command signal indicative of an air conditioner automatic control condition. The temperature setting switch 81 is provided for setting a temperature of the passenger compartment.

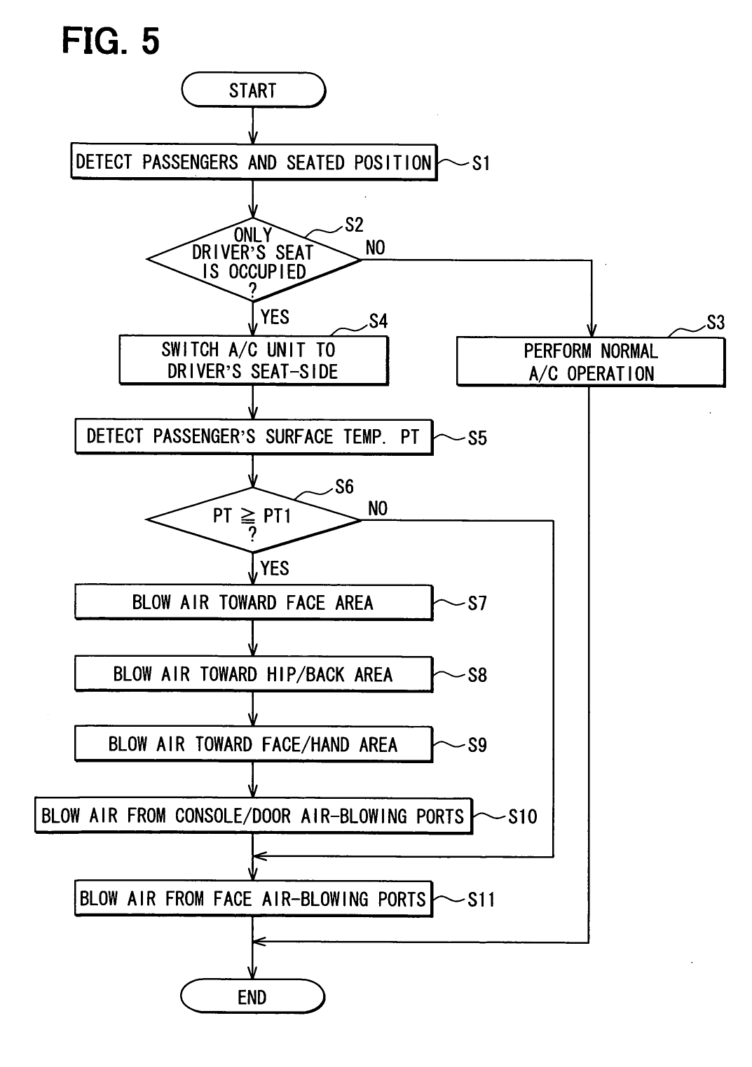

An operation of the air conditioner of the present embodiment will be described with reference to FIGS. 5 to 10. FIG. 5 shows a flow of a cool-down control of the air conditioner. Here, it is assumed that, in a hot condition, such as in summer, there is only a passenger on a driver's seat of a vehicle, and the air-conditioner switch 78 is on.

First, when a passenger gets in the vehicle, in S1, the number of passenger(s) and the seated positions where the passenger(s) is (are) seated are detected by the seat sensor 74. In S2, it is determined whether the number of passenger(s) detected by the seat sensor 74 is one and the seated position of the passenger is on the driver's seat. When it is determined in S2 that only the driver's seat is occupied by the passenger, the processing proceeds to S4. When it is determined in S2 that there is another passenger other than the passenger on the driver's seat, the processing proceeds to S3 to perform a normal air conditioning operation for an entire space of the passenger compartment.

In S4, one of the right unit 10 and the left unit 11 is operated in accordance with the detection result of S2. Namely, operation of the interior air conditioning unit 1 is switched to one of the right unit 10 and the left unit 11, the one corresponding to the seat occupied by the passenger. In this case, only the driver's seat is occupied, an operation of the right unit 10, such as an operation of the blower 25 of the right unit 10 is started, but an operation of the left unit 11, such as an operation of the blower 25 of the left unit 11 is not started.

As such, only the unit 10, 11 that corresponds to the side on which the passenger is detected is operated so that the conditioned air is blown from the air-blowing outlet portions that are on the corresponding side. Accordingly, air conditioning efficiency of the air conditioner improves.

In S5, a surface temperature PT (e.g., skin temperature) of the detected passenger is detected by the IR sensor 75. In S6, it is determined whether or not the detected surface temperature PT is equal to or higher than a first predetermined temperature PT1.

When it is determined that the surface temperature PT is equal to or higher than the first predetermined temperature PT1, it is judged that the cool-down control is necessary. Thus, the processing proceeds to S7 to conduct the cool-down control.

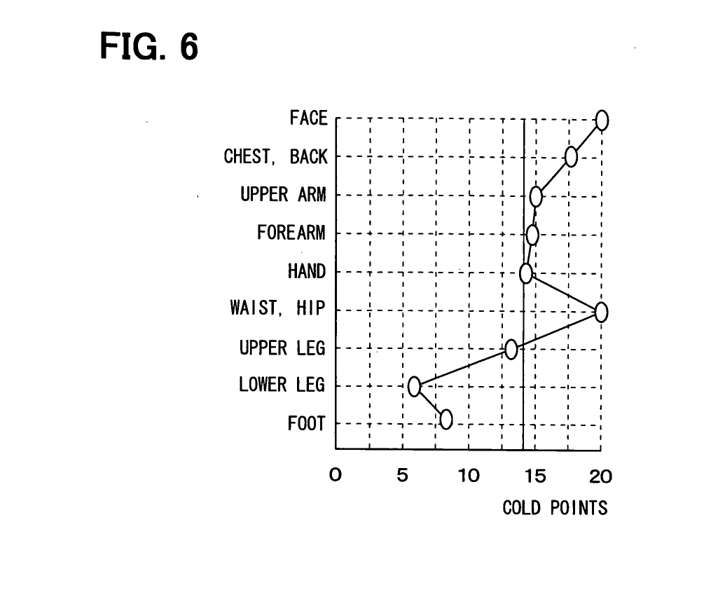

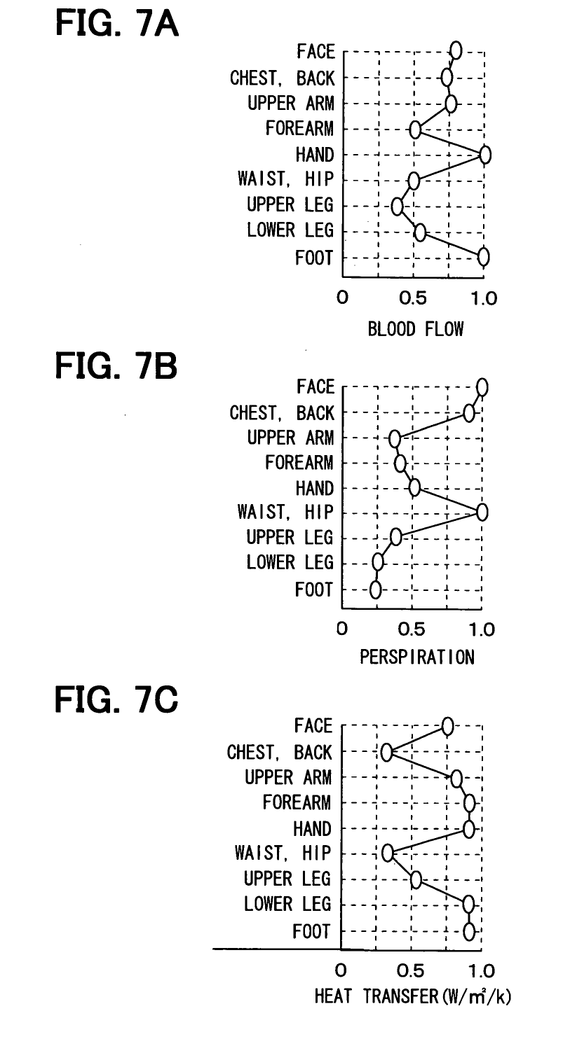

Here, the cool-down control of the present embodiment will be described in detail with reference to FIGS. 6, 7A, 7B, and 7C. FIG. 6 shows distribution of cold points of human skin, that is, distribution of points that sense the cold in human skin. In FIG. 6, a vertical axis represents parts of a human body, and a horizontal axis represents the number of cold points per square centimeter.

The more the number of cold points increases, the more the magnitude that a person feels cold increases. Thus, as shown in FIG. 6, a person feels the coldest in his face, and the cold feeling reduces in the order of waist/hip, chest/back, arm, and hands.

FIG. 7A, 7B, 7C show efficiency of heat exchange of respective parts of a human body. FIG. 7A shows a rate of change of blood flow of a human skin. FIG. 7B shows the amount of perspiration per unit area of a human body. FIG. 7C shows a coefficient of heat transfer of a human body.

In FIG. 7A, a vertical axis represents parts of a human body, and a horizontal axis represents a ratio of the rate of change of blood flow of each body part to that of a body part having the largest rate. In FIG. 7B, a vertical axis represents parts of a human body, and a horizontal axis represents a ratio of the amount of perspiration of each body part to that of a body part having the largest amount. In FIG. 7C, a vertical axis represents parts of a human body, and a horizontal axis represents the coefficient of heat transfer. Here, it is determined that a body part that has a higher level in at least one of the change of blood flow, the amount of perspiration and the coefficient of heat transfer is easily cooled such as by outside air since the amount of heat radiation in such a body part is high.

According to the efficiency of heat exchange shown in FIGS. 7A, 7B and 7C, the rate of change of blood flow is relatively high in hands and foot. The amount of perspiration is relatively high in a face, waist/hip and chest/back and the like. The coefficient of heat transfer is relatively high in arms, hands, lower legs and foot.

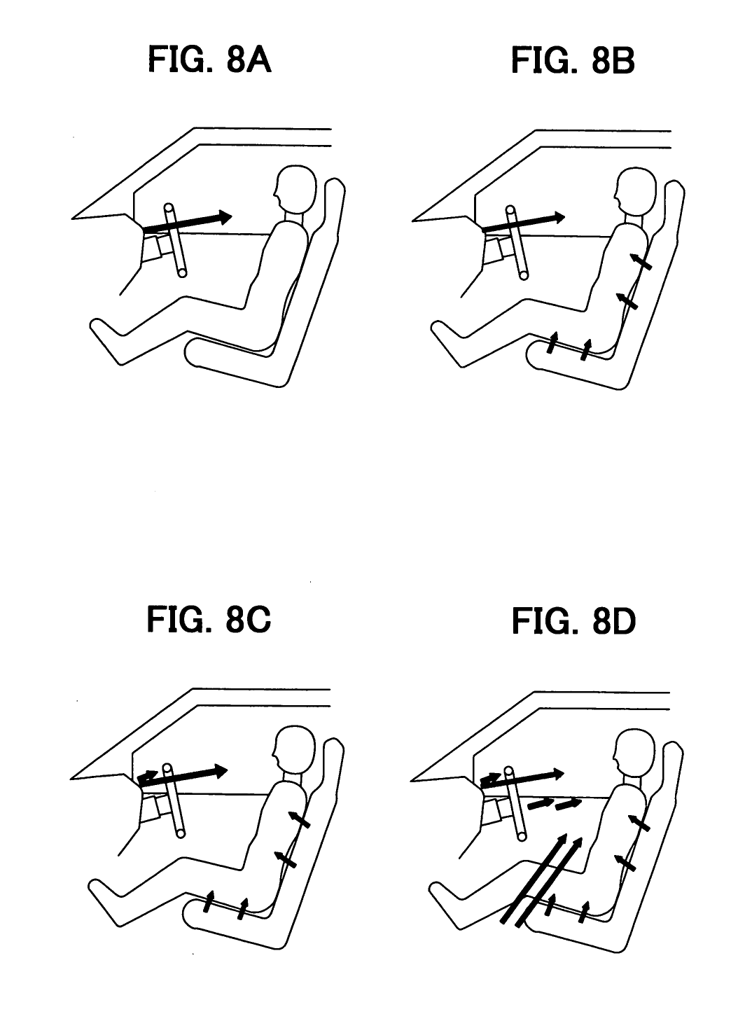

The cool-down control of the present embodiment is performed in consideration of the distribution of the cold points and the efficiency of heat transfer in a human body. Thus, the conditioned air (cool air) is blown first toward the body part at which the passenger wants to cool the most in his body. Namely, as shown in FIG. 8A, the conditioned air is blown first toward the face area that has the highest density in the cold points, an amount of perspiration, and is exposed to the air. Here, FIGS. 8A, 8B, 8C, 8D show blowing operations for blowing the conditioned air toward target portions of a target passenger in the cool-down control.

In this case, since the passenger is seated on the driver's seat, the conditioned air is blown only from the center right face air-blowing outlet portion 40a and the right side face air-blowing outlet portion 41a. The conditioned air is not blown from the center left face air-blowing outlet portion 40b and the left side face air-blowing outlet portion 41b.

In S8, when the surface temperature PT detected by the IR sensor 75 reduces equal to or lower than a second predetermined temperature, the conditioned air (cool air) is blown from the seat 6 that contacts the passenger (e.g., hip area) and has a second largest heat transferring area with the passenger, following the air (surrounding air). The second predetermined temperature is determined based on experiments and the like. The second predetermined temperature is higher than the first predetermined temperature PT1.

The hip area of the passenger has high density in the cold points and an amount of perspiration, following the face. Also, the hip area contacts the seat 6, which has a large heat capacity (heat mass). Thus, a blowing operation for blowing the conditioned air toward a contact portion of a passenger that contacts the seat 6 (hereinafter, seat-contact portion) is begun, following a blowing operation for blowing the conditioned air toward the face area, so that the hip is cooled following the face. In this case, in addition to the right unit 10 that is in operation for blowing the conditioned air toward the face, the console air conditioning unit 2 is operated for blowing the conditioned air from the seat air-blowing outlet portion 45.

Thus, in S8, the conditioned air generated in the right unit 10 is blown toward the face area from the center right face air-blowing outlet portion 40a and the right face air-blowing outlet portion 41a, and the conditioned air generated in the console air conditioning unit 2 is blown toward the hip and back of the passenger from the seat air-blowing outlet portion 45, as shown in FIG. 8B In this case, the conditioned air generated in the console air conditioning unit 2 is blown only from the right seat air-blowing outlet portion 45, which is located on the driver's seat side.

In S9, when the temperature of the seat surface detected by the seat temperature sensor 73 reaches a predetermined seat temperature (i.e., seat comfortable temperature), the conditioned air is blown toward the hand area of the passenger by means of the air-flow direction adjustment device for cooling the hands, in addition to the blowing operation toward the face, as shown in FIG. 8C.

With regard to the hands, the rate of change of the blood flow is high, and the coefficient of heat transfer is high. Thus, the passenger wants to cool his hands, following the face, hip and the like. As such, a blowing operation for blowing the conditioned air toward the hands is begun following the blowing operations toward the face area and the seat-contact portion so that the hands are cooled following the face, hip and the like.

Further, as shown in FIG. 7A, the deep body temperature of a human body is reduced by radiating heat at extremities, such as hands, through blood circulation. Thus, the heat of the deeply inside of the body is radiated by cooling the hands. However, it is easier to lower the skin temperature (surface temperature) than the deep body temperature. Therefore, the hands are cooled, after the face, the hip and the like are cooled for lowering the surface temperature.

Accordingly, in consideration of the distribution of the cold points of the human skin and the efficiency of heat transfer, the blowing operation for blowing the conditioned air is concentrated to the face area first, then provided to the seat-contact portion in addition to the blowing operation toward the face area, and thereafter, provided to the hand area. As such, a quick effect of the cool-down control improves.

In this case, the blowing operation toward the hand area is performed by blowing the conditioned air from one of the center right face air-blowing outlet portion 40a and the right side face air-blowing outlet portion 41a. Also, the conditioned air from one of the center right face air-blowing outlet portion 40a and the right side face air-blowing outlet portion 41a is directed toward the hand area by controlling the air-flow direction adjustment grill 46.

The position of the hands of the passenger is detected based on the temperature distribution detected by the IR sensor 75. For example, when the passenger detected by the seat sensor 74 is a driver, the conditioned air is generally blown toward a steering wheel of the vehicle.

In S10, when the surface temperature PT detected by the IR sensor 75 reduces equal to or lower than a third predetermined temperature, the volume of conditioned air blown from the face air-blowing outlet portions 40a, 41a and the seat air-blowing outlet portion 45 is gradually reduced and a blowing operation for blowing the conditioned air (e.g., cool air) toward the chest and arms of the passenger is performed. Here, the blowing operation toward the chest and arms is performed by blowing the conditioned air from the door air-blowing outlet portion 43 and the console air-blowing outlet portion 44, which are on the side where the passenger is detected, as shown in FIG. 8D. The third predetermined temperature is determined based on experiments and the like. The third predetermined temperature is higher than the first predetermined temperature and is lower than the second predetermined temperature.

With regard to the chest and arms of the human body, the efficiency of heat exchange is high. Thus, as a cooling condition of the face, the hands and the seat-contact portion become thermal-sensuously stable by the blowing operations of the cool air, the passenger is likely to start to feel uncomfortable in his chest and arm area due to disturbance of solar radiation and the like.

Therefore, the blowing operation toward the chest and arm area of the passenger is performed, following the blowing operation toward the hand area. In addition, the conditioned air from the door air-blowing outlet portion 43 and the console air-blowing outlet portion 44 can be also blown toward the upper legs in which the distribution of the cold points is relatively high. In this case, passenger comfort will be further improved.

In S11, when the surface temperature PT detected by the IR sensor 75 reduces equal to or lower than the first predetermined temperature PT1, the cool-down control is finished. Thereafter, a blowing operation for blowing the conditioned air from the face air-blowing outlet portions 40a, 41a is performed.

In this case, a swing control for swinging the air-flow direction adjustment grills 46 of the face air-blowing outlet portions 40a, 41a. Namely, the conditioned air is blown from the face air-blowing outlet portions 40a, 41a while swinging the air-flow direction adjustment grills 46. The passenger is likely to start to feel the direct airflow unpleasant after an area around the passenger is cooled and becomes a thermal-sensuously stable condition. Namely, if the conditioned air is blown toward the target area in a concentrated manner after the cool-down control is finished, the passenger will have unpleasant feeling, such as cold draft (e.g., local excessive cold feeling). Thus, the conditioned air is blown toward the target area in a swinging manner.

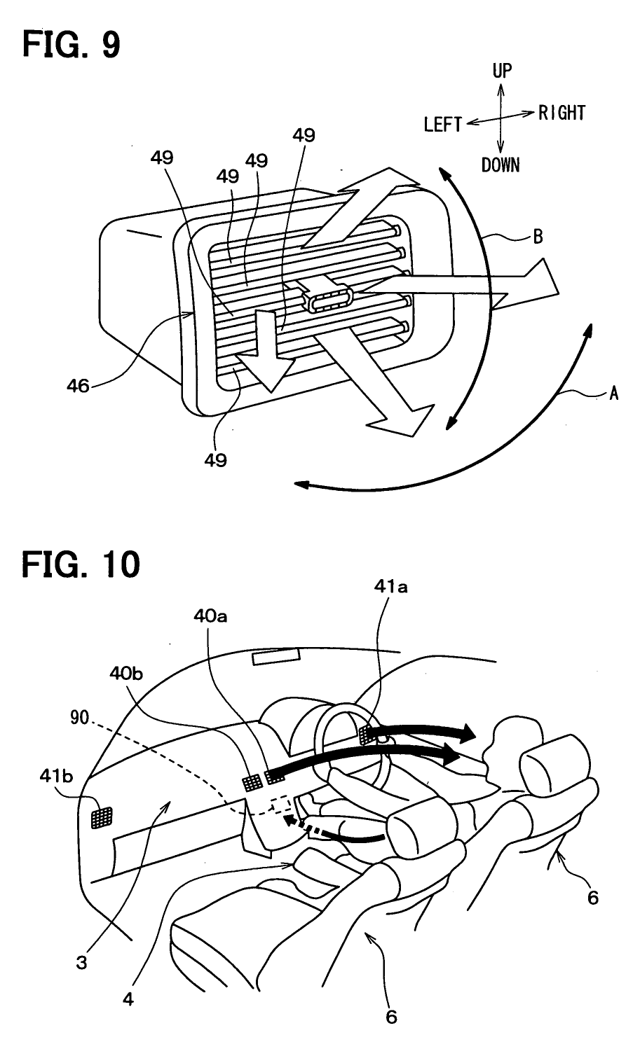

For example, the vertical louver 48 of the air-flow direction adjustment grill 46 is swung in the right and left direction as shown by an arrow A in FIG. 9, and/or the horizontal louver 49 of the air-flow direction adjustment grill 46 is swung in the up and down direction as shown by an arrow B in FIG. 9. For example, the conditioned air is blown toward a face area and a neck area while swinging the horizontal louver 49 in the up and down direction.

Since the conditioned air is blown toward the target area in the swinging manner, a comfortable air conditioning operation is provided.

In S6, when the surface temperature PT detected by the IR sensor 75 is smaller than the first predetermined temperature PT1, it is determined that the cool-down control is unnecessary. Thus, the blowing operation of S11 is performed only for the passenger seated on the driver's seat.

Thereafter, the operation of the blower and the like of the air conditioner is stopped, for example, in response to the turning off of the air conditioner switch 78.

In the above cool-down control, in a case where an air suction mode is set to an inside air circulation mode in which the inside air is introduced into the inside/outside air switching device 21 from the inside air introduction port 22, the conditioned air that has been blown off from the face air-blowing outlet portions 40a, 41a toward the passenger can be drawn into the inside/outside air switching device 21 from the air suctioning portion 90 provided at the foot area of the passenger. In this case, because the air can be circulated around the target passenger, an air-conditioning efficiency of the air conditioner is improved while saving power.

In the present embodiment, the conditioned air generated in the right unit 10 is blown toward the face of the passenger from the face air-blowing outlet portions 40, 41 (40a, 41a) first, and then the conditioned air generated in the console air conditioning unit 2 is blown from the seat air-blowing outlet portion 45 in addition to the conditioned air blown toward the face.

Further, as the seat temperature sensor 73 detects that the seat-contact portion becomes in the thermal-sensuously stable condition, the conditioned air is blown toward the hands from at least one of the center right face air-blowing outlet portion 40a and the right side face air-blowing outlet portion 41a, in addition to the blowing operations toward the face and the seat-contact portion. Moreover, the conditioned air (cool air) is blown from the side air-blowing outlet portions 43, 44 of the console 4 and the side door 5 since the area around the door is likely to be affected by a thermal load such as solar radiation and the like.

In this way, timing of blowing the conditioned air toward the target portions of the passenger is decided in consideration of the distribution of the cold points of the human skin and the efficiency of heat exchange. Therefore, since the immediate effect of the air conditioning operation is improved, the air conditioning efficiency is improved while saving power.

Further, in the case where there is only one passenger in the passenger compartment, the air conditioning capacity is concentrated by performing the blowing operation for the target passenger. Therefore, the air conditioning efficiency of the air conditioner is improved while saving power.

Furthermore, only one of the right unit 10 and the left unit 11, which corresponds to the side where the passenger is detected, is operated. Therefore, the air conditioning efficiency is improved while saving power.

### Second Embodiment

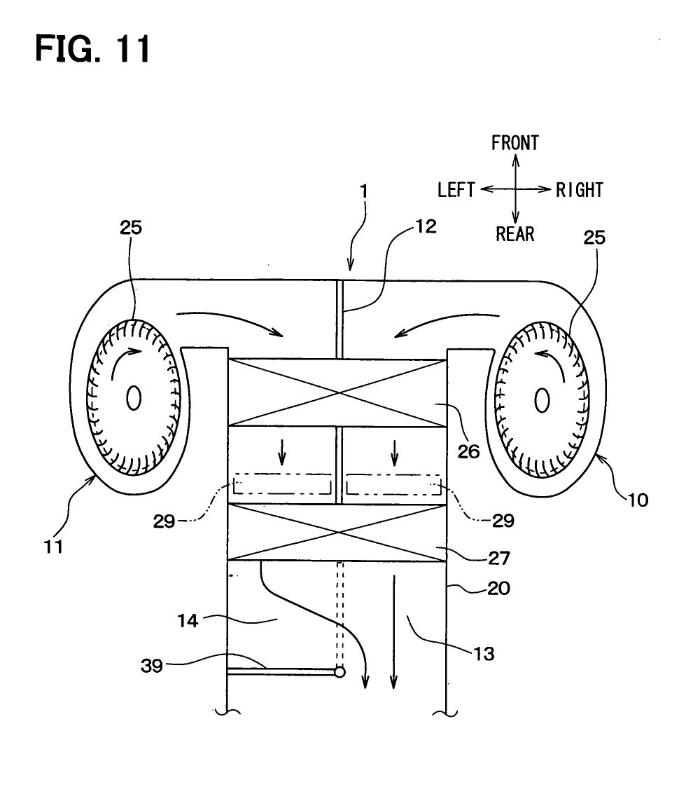

A second embodiment of the present invention will be described with reference to FIG. 11. Hereinafter, like components are denoted by like reference characters and a description thereof is not repeated.

In the first embodiment shown in FIG. 3, the air conditioning case 20 of the interior air conditioning unit 1 is divided into the right passage 13 and the left passage 14 from an upstream position to a downstream position by the partition wall 12. In the second embodiment, on the other hand, the air conditioning case 20 is provided with a right/left switching door 39 at a position downstream of the heater core 27, in place of the partition wall 12.

The right/left switching door 39 is rotatably supported in the air conditioning case 20, and is driven by a servomotor (not shown) so that the rotational position of the right/left switching door 39, that is, the opening degree is controlled. In the air conditioning case 20, the face opening 30, the foot opening 31, the defroster opening 32 and the door opening 33 are respectively divided into the right opening portions and the left opening portions. The right/left switching door 39 is operable to fully close one of the right opening portions and the left opening portions.

During controls other than a specific control, such as the cool-down control, the right/left switching door 39 is moved to a position to separate the right passage 13 and the left passage 14 (e.g., the position shown by dashed line in FIG. 11). In this case, the right/left switching door 39 serves as a part of the partition wall 12.

In the first embodiment, the evaporator 26 and the heater core 27 are provided in each of the right unit 10 and the left unit 11. In the present embodiment, on the other hand, the evaporator 26 and the heater core 27 are shared between the right passage 13 and the left passage 14.

In the cool-down control of the present embodiment, in a step corresponding to S4 of FIG. 5, the right/left switching door 39 is moved to a position so that one of the right opening portions and the left opening portion, which corresponds to the side where the passenger is detected, are fully opened and the other, which corresponds to the side where the passenger is not detected, are fully closed, instead of switching the operation to one of the right unit 10 and the left unit 11.

Accordingly, a maximum cooling capacity of the interior air conditioning unit 1 is improved. Therefore, the immediate effect of the air conditioner is improved.

### Third Embodiment

A third embodiment of the present invention will now be described. Hereinafter, operations different from those of the first embodiment will be mainly described.

In the cool-down control of the present embodiment, the blowing operation toward the face area is performed, in the similar manner as S7 of FIG. 5. For example, in a case where the passenger is detected on the driver's seat side, the conditioned air generated in the right unit 10 is blown toward the face area from the center right face air-blowing outlet portion 40a and the right side face air-blowing outlet portion 41a.

Then, in a step corresponding to S8 of FIG. 5, when the surface temperature TP of the passenger face area, which is detected by the IR sensor 75, becomes equal to or lower than the second predetermined temperature, the operation of the right unit 10 is stopped, and the console air conditioning unit 2 is operated so that the conditioned air generated in the console air conditioning unit 2 is blown toward the hip and back of the passenger only from the seat air-blowing outlet portion 45.

In a step corresponding to S9 of FIG. 5, when the surface temperature of the seat 6, which is detected by the seat temperature sensor 73, reaches the seat comfortable temperature, the operation of the console air conditioning unit 2 is stopped and the right unit 10 is operated so that the conditioned air generated in the right unit 10 is blown only toward the hands of the passenger.

In a step corresponding to S10 of FIG. 5, the console air conditioning unit 2 can be operated so that the conditioned air is blown from the respective air-blowing outlet portions toward the predetermined portions.

Accordingly, in the present embodiment, the blowing operations toward the face area, the seat-contact portion and the hand area are successively performed while operating the corresponding air conditioning unit timely. Namely, the conditioned air is blown successively toward the face area, the seat-contact portion (e.g., hip and back), and the hand area in this order. Further, the air conditioning unit that does not correspond to the target cooling portion is stopped. Thus, the air conditioning capacity of concentrated only to the target cooling portion. As such, the air conditioning efficiency of the air conditioner is improved while saving power.

(Modifications)

The present invention is not limited to the above described embodiments, but may be implemented in various ways as follows.

(1) In the above embodiments, the necessity of the cool-down control is determined based on the relationship between the surface temperature PT of the passenger detected by the IR sensor 75 and the predetermined first temperature PT1. (i.e., S5) Alternatively, the necessity of the cool-down control may be determined based on any other factors. For example, a temperature difference ΔT between the inside air temperature TR detected by the inside air sensor 71 and the set temperature set by the temperature setting switch 81 or a temperature difference ΔT between the inside air temperature TR and a target air-blowing temperature (TAO) is calculated by the air conditioner control unit 100. The necessity of the cool-down control can be determined based on a relationship between the temperature difference ΔT calculated by the control unit 100 and a predetermined temperature difference. In this case, when the calculated temperature difference ΔT is equal to or greater than the predetermined temperature difference, it is determined that the cool-down control is necessary. On the other hand, when the calculated temperature difference ΔT is smaller than the predetermined temperature difference, it is determined that the cool-down control is not necessary.

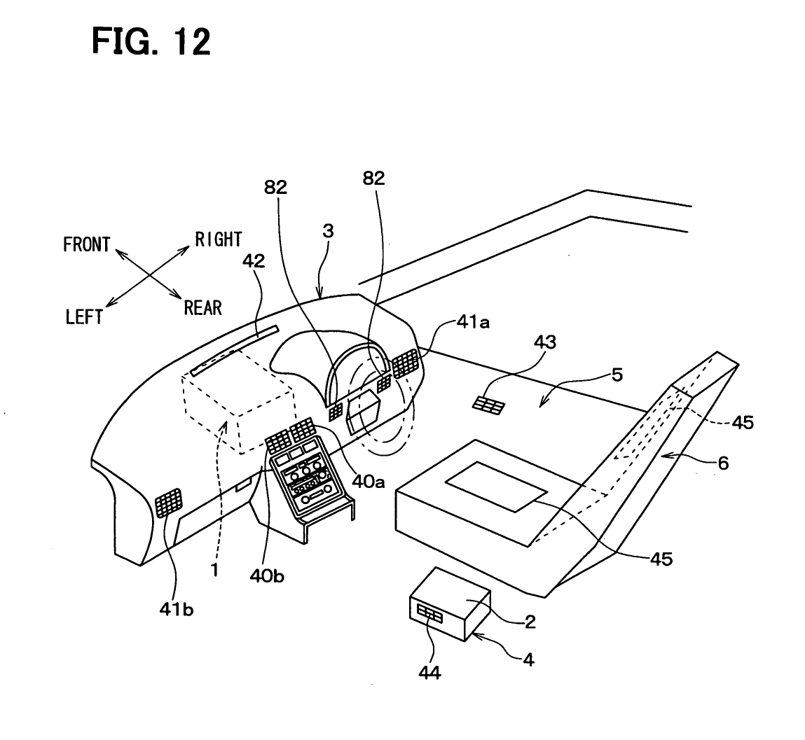

(2) In the above embodiments, the blowing operation toward the hand area is performed by blowing the conditioned air from the face air-blowing outlet portions 40, 41. However, the blowing operation toward the hand area can be performed in different manner. For example, as shown in FIG. 12, hand air-blowing outlet portions 82 can be formed on the instrument panel 3 adjacent to the steering wheel, and the conditioned air toward the hand is blown from the hand air-blowing outlet portions 82. As another example, the steering wheel may be configured such that the conditioned air is blown toward the hands from the steering wheel. Also, the blowing operations toward the other portions, such as the face, hip and the like, may be performed by blowing the conditioned air in different ways as the above described manner.

(3) In the above embodiments, the air conditioner includes the console air conditioning unit 2 for generating conditioned air to be blown from the seat 6 and the console 4. However, the air conditioner may not have the console air conditioning unit 2. In this case, the conditioned air generated in the interior air conditioning unit 1 can be introduced to the seat 6 and the console 4 through ducts.

(4) In the above embodiments, the cool-down control is conducted when only one passenger is detected in the vehicle by the seat sensor 74. However, the cool-down control of the above embodiments can be also conducted in a case where there are plural passengers in the vehicle and the number of the passengers is equal to or less than a predetermined number. In this case, the cool-down control is conducted for each of the passengers. For example when the passengers are seated only on the driver's seat and the front passenger's seat, the cool-down control is conducted focusing on the passengers on the driver's seat and the front passenger's seat by operating the blowers and the like of the right and left units 10, 11 and the console air conditioning unit 2.

(5) In the above embodiments, the seated condition of each seat 6, that is, whether or not the seat 6 is occupied by the passenger is detected by the seat sensor 74. However, the seated condition of each seat 6 may be determined in other ways. For example, the number of passengers and the seated positions of the passengers are detected based on the temperature distribution inside of the passenger compartment detected by the IR sensor 75. Thus, whether or not the seat 6 is occupied can be determined based on the number of passengers and the seated positions.

(6) In the cool-down control of the above embodiments, the conditioned air is blown toward the target portions of the passenger body in the concentrated manner. In this case, when the temperature of the target portion is reduced to a predetermined temperature, the air-flow direction adjustment grill 46 can be swung such that the conditioned air is swung between the target portion and the vicinity of the target area, similar to FIG. 9. Therefore, it is less likely that the passenger will have unpleasant feeling and cold draft due to the concentrated airflow.

(7) In the cool-down control of the third embodiment, the blowing operations toward the face area, the seat-contact portion, and the hand area are successively performed while stopping the operation of the air conditioning unit that does not corresponds to the target air-blowing outlet portion. However, the operation may be modified in various ways as long as the blowing operations toward the face area, the seat-contact portion (e.g., hip and back) and the hand area are successively begun. For example, the on and off of the console air conditioning unit 2 is switched while continuing the operation of the interior air conditioning unit 1. Also in this case, the air conditioning efficiency of the air conditioner is improved while saving power.

Additional advantages and modifications will readily occur to those skilled in the art. The invention in its broader term is therefore not limited to the specific details, representative apparatus, and illustrative examples shown and described.

What is claimed is:

1. An air conditioner for a vehicle, comprising:
an air conditioning unit for generating a conditioned air;
an air-blowing outlet portion in communication with the air conditioning unit and capable of blowing the conditioned air toward a target portion including a face area, a seat-contact portion and a hand area of a passenger in a passenger compartment of the vehicle, the seat-contact portion contacting a seat of the vehicle; and
a control unit adapted to conduct a cool-down control including a first blowing operation for blowing the conditioned air from the air-blowing outlet portion toward the face area, a second blowing operation for blowing the conditioned air from the air-blowing outlet portion toward the seat-contact portion and a third blowing operation for blowing the conditioned air from the air-blowing outlet portion toward the hand area, wherein
the first blowing operation, the second blowing operation and the third blowing operation successively begun.

2. The air conditioner according to claim 1, wherein
the second blowing operation is begun while performing the first blowing operation, and
the third blowing operation is begun while performing the first and second blowing operations.

3. The air conditioner according to claim 1, wherein
the second blowing operation is begun after the first blowing operation is finished, and
the third blowing operation is begun after the second blowing operation is finished.

4. The air conditioner according to claim 1, wherein
the target portion further includes an upper body area that corresponds to at least one of a chest portion and an arm portion of the passenger, and
the cool-down control further includes a fourth blowing operation for blowing the conditioned air toward the upper body area, wherein
the fourth blowing operation is begun after the third blowing operation is begun.

5. The air conditioner according to claim 1, wherein
the air-blowing outlet portion includes a face air-blowing port, and
the first blowing operation is performed by blowing the conditioned air from the face air-blowing port toward the hand area.

6. The air conditioner according to claim 1, further comprising:
an air-flow direction adjustment device disposed in the air-blowing outlet portion for adjusting a flow direction of the conditioned air blown from the air-blowing outlet portion; and
a temperature detecting device configured to detect a surface temperature of the target portion of the passenger, wherein
when the surface temperature detected by the temperature detecting device is equal to or lower than a predetermined temperature, the control unit swings the air-flow direction adjustment device such that the conditioned air is blown from the air-blowing outlet portion toward the target portion in a swinging manner.

7. The air conditioner according to claim 1, further comprising:
an air suctioning portion disposed adjacent to the seat in the passenger compartment and defining a suction port for suctioning the conditioned air blown from the air-blowing outlet portion, wherein
the cool-down control includes an air suctioning operation for suctioning the conditioned air blown from the air-blowing outlet portion by at least one of the first to third operations.

8. The air conditioner according to claim 1, further comprising:
a passenger detecting device for detecting a seated condition of the passenger, wherein
the cool-down control is conducted for the passenger detected by the passenger detecting device.

9. The air conditioner according to claim 8, wherein
when it is detected by the passenger detecting device that only a driver's seat of the vehicle is occupied by a passenger, the coo-down control is conducted toward the driver's seat.

10. The air conditioner according to claim 8, wherein
the air conditioning unit includes a first unit for generating a conditioned air to be blown toward a right space of the passenger compartment and a second unit for generating a conditioned air to be blown toward a left space of the passenger compartment, and
when the passenger detecting device detects a passenger only in one of the right space and the left space of the passenger compartment, one of the first and second units, which corresponds to the space in which the passenger is detected, is operated.

11. The air conditioner according to claim 8, wherein
the air-blowing outlet portion is provided in each of a right space and a left space of the passenger compartment, and
when the passenger detecting device detects a passenger only in one of the right space and the left space of the passenger compartment, the conditioned air is blown from the air-blowing outlet portion that is provided in the space in which the passenger is detected.

12. The air conditioner according to claim 1, wherein
the air-blowing outlet portion includes a face air-blowing port formed on an instrument panel of the vehicle and a seat air-blowing port formed in the seat,
the first and this blowing operations are performed by blowing the conditioned air from the face air-blowing port, and
the second blowing operation is performed by blowing the conditioned air from the seat air-blowing port.
